(19) United States
(12) Patent Application Publication
(10) Pub. No.: US 2021/0179476 A1
(43) Pub. Date: Jun. 17, 2021

(54) MEANS FOR IMMOBILIZING A PANE

(71) Applicant: SAINT-GOBAIN GLASS FRANCE, COURBEVOIE (FR)

(72) Inventors: Arthur PALMANTIER, AACHEN (DE); Arnaud BORDERIOU, COMPIEGNE (FR); Romain DEBAILLEUL, VILLERS SUR COUDUN (FR); Achim ZEICHNER, HERZOGENRATH (DE); Christophe MACHURA, CHEVINCOURT (FR); Peter SCHILLINGS, ESCHWEILER (DE)

(21) Appl. No.: 16/758,695

(22) PCT Filed: Oct. 18, 2018
(86) PCT No.: PCT/EP2018/078483

§ 371 Date: Apr. 23, 2020

(30) Foreign Application Priority Data
Oct. 27, 2017 (EP) 17198770.4

(51) Int. Cl. C03B 35/20; C03B 23/03

(52) U.S. Cl. CPC C03B 35/207; C03B 2225/02; C03B 23/03

(57) ABSTRACT

An apparatus for immobilizing a pane having a circumferential side edge within a positional tolerance on a carrier mold, wherein the apparatus includes a stopper, which is movable between a first position and a second position, which has a free end and an end opposite the free end that is connected to a device for moving the stopper between the first position and the second position. In the second position, the free end of the stopper is directed toward the side edge of the pane to be immobilized and the distance between the free end of the stopper and the side edge corresponds at most to the positional tolerance. In the first position, the free end of the stopper is offset back and/or upward in the plane of the pane compared to the second position.

The invention relates to a means for immobilizing a pane resting on a carrier mold.

A large number of bending methods for glass panes are described in the patent literature.

EP 0 448 447 A1 and EP 0 705 798 A1 describe in each case a method and devices for bending glass panes on doubled frames, wherein, in a first bending step, the glass panes are pre-bent by gravity on a pre-bending frame and then bent by gravity to their final shape in a second bending step on a primary bending frame. The passage of the glass pane from the pre-bending frame to the primary bending frame is done by moving the pre-bending frame away from the primary bending frame.

WO 2012/080072 A1 describes a method with incremental bending of glass panes in the edge region and the inner region. Here, the glass pane is first moved on a pre-bending ring into a furnace, wherein the pane edge is pre-bent by gravity, followed by further bending of the pane edge by a first suction device, placement and bending of the glass pane in the surface on a final bending ring and final bending to the desired final geometry by means of a second suction device.

WO 2004/087590 A2 and WO 2006/072721 A1 describe in each case a method in which the glass pane is first pre-bent by gravity on a bending frame, followed by press bending using an upper or lower bending mold.

In the conventional gravity bending method, the carrier molds pass one after another through a chamber heated to the bending temperature of the glass. In this method, the carrier molds are not subjected to high accelerations during transport such that the panes remain in the correct position on the carrier mold without additional holding.

When a carrier mold for a pane is subjected to high accelerations during transport, the inertia of the pane causes the pane to slip on the carrier mold, in other words, the position of the pane changes relative to the carrier mold.

U.S. Pat. No. 4,074,996 A describes a bending method in which the edge region of the pane to be bent is held by clamping tools.

JP 3 573217 B2 discloses a means for immobilizing a pane on a carrier mold, in which the pane is immobilized by a pin inserted into an opening in the pane.

WO 2016/189319 A1 discloses means for the proper positioning of a pane relative to a first bending tool, wherein the means actively shift the pane from a first position to a second position.

The object of the present invention consists in providing an improved means by which a pane can be held in a proper position on a carrier mold when the carrier mold is transported and is subjected during transport to high acceleration, in particular of at least 500 mm/s² or even at least 1500 mm/s² or even at least 3000 mm/s² or even at least 5000 mm/s². In general, the acceleration is less than 7500 mm/s². This acceleration is usually directed laterally.

These and other objects are accomplished according to the proposal of the invention by a means for immobilizing a pane, a carrier mold, a device and a method for transporting a pane on a carrier mold, and a method for bending panes with the features of the coordinate claims. Advantageous embodiments of the invention are apparent from the dependent claims.

The term “pane” refers in particular to a glass pane, preferably a soda lime glass to be thermally tempered.

The term “acceleration” covers both positive and negative accelerations. Thus, for example, deceleration is negative acceleration and is also covered by the term “acceleration”.

The terms “lateral/laterally” or “lateral movement” refer to a horizontal movement or a movement with at least one horizontal movement component.

The invention relates primarily to a means for immobilizing, i.e., positionally fixing, a pane, wherein the carrier mold can be transported and thus can be subjected to a laterally directed movement. The pane has a circumferential side edge and can be immobilized on the support surface of the carrier mold by the means for immobilizing. This at least one means for immobilizing, in short, immobilization means, ensures that during transport, even at high accelerations of the carrier mold in a lateral direction, only slight lateral movement or no lateral movement of the pane relative to the carrier mold occurs, in other words, the pane remains substantially stationary on the support surface of the carrier mold.

As used here and in the following, the term “immobilizing/immobilization” refers to fixing the position of the pane on a carrier mold within a certain positional tolerance. The positional tolerance is, in accordance with the requirements of the individual case, defined in advance; and the immobilization means is positioned and/or configured accordingly. Thus, the pane is substantially stationarily connected to the carrier mold, in other words, in particular during movement of the carrier in the lateral direction, the position of the pane relative to the carrier mold changes only to a small extent or not at all.

A change of position relative to the carrier mold “to a small extent” means, here and in the following, in particular a change of position within a positional tolerance of at most ±4 mm, in particular at most ±2 mm, preferably at most ±1 mm, particularly preferably at most ±0.5 mm, most particularly preferably at most ±0.1 mm in a horizontal direction.

The means according to the invention for immobilizing a pane having a circumferential side edge comprises a stopper movable between a first position (A) and a second position (B). One end of the stopper is a free end and an end opposite the free end of the stopper is connected to a means for moving the stopper between the first position (A) and the second position (B). The stopper is, in the position (B), suitable for preventing slippage of the pane outside a positional tolerance.

As used here and in the following, the term “circumferential side edge” or “side edge” refers to the lateral edge of the pane and not to the upper side or the lower side (primary surfaces) of the pane.

According to the invention, in the second position (B), the free end of the stopper is directed toward the side edge of the pane to be immobilized and the distance between the free end of the stopper and the side edge of the pane corresponds at most to the positional tolerance.

According to the invention, in the first position (A), the free end of the stopper is offset back and/or upward compared to the second position (B) in the plane of the pane.

In a preferred embodiment, in the second position (B), the distance between the free end of the stopper and the side edge of the pane to be immobilized is at least 0.1 mm.

In one embodiment, the distance between the free end of the stopper and the side edge of the pane to be immobilized is, in the second position, at most 4 mm, preferably at most 2 mm, particularly preferably at most 0.5 mm, most particularly preferably 0.1 mm to 0.5 mm, in particular 0.1 mm

The means for moving the stopper between the first position (A) and the second position (B) can have any suitable form. This means can, for example, be a motor-driven mechanical component or a cylinder. Preferably, the means for moving the stopper between the first position (A) and the second position (B) is a cylinder. Such a cylinder comprises a piston with a piston rod connected thereto, which is movable between a first position and a second position in a cylinder tube, and a component that is suitable for transferring the movement of the piston and the piston rod connected thereto to the stopper.

In this embodiment, the stopper of the immobilization means according to the invention has a free end and an end opposite the free end, which is connected to the cylinder, or more precisely to the component of the cylinder suitable for transferring a movement.

The component transferring the movement of the piston and the piston rod connected thereto to the stopper can be rigid or preferably in the form of a joint mechanism. The joint mechanism comprises at least one joint, preferably two joints, particularly preferably three joints.

The cylinder can be an electric cylinder, a hydraulic cylinder, or a pneumatic cylinder, with a pneumatic cylinder being preferable in particular at high temperatures, i.e., temperatures of more than 200° C. or even of more than 500° C.

In a preferred embodiment, the cylinder is a pneumatic cylinder. The cylinder is, in this case, operated with compressed air. The compressed air is preferably supplied to the cylinder via rigid tubes, with two rigid tubes connected to the cylinder for supplying compressed air. The cylinder tube is divided into two regions by the movable piston. The compressed air, which can be fed into the cylinder via one of the rigid tubes, is introduced into one region of the cylinder tube such that it can press against the piston from one side, and the compressed air, which can be fed into the cylinder via the other one of the rigid tubes, is introduced into the other region of the cylinder tube such that it can press against the piston from the other side. In this manner, the position of the piston and the cylinder tube can be adjusted by supplying compressed air via one tube or the other. The pressure at which the compressed air can be supplied via the rigid tubes can be adjusted via valves upstream from the rigid tubes. The pressure is preferably 0.5 to 6 bar, particularly preferably 1.5 to 3 bar, most particularly preferably 2 bar.

According to the invention, the free end of the stopper is, in the first position, offset back and/or upward compared to the second position in the plane of the pane. Preferably, the free end of the stopper is, in the first position, farther from the side edge of the pane to be immobilized than in the second position. While the position of the cylinder piston is in the second position, the free end of the stopper is directed toward the side edge and reaches the side edge of the pane to be immobilized and the position of the pane is fixed thereby, i.e., the attaching means is activated. The pane can, in the first position of the stopper, thus be conveniently removed or placed.

In the embodiment, in which the means for moving the stopper between the first position (A) and the second position (B) is a pneumatic cylinder, the cylinder piston of the cylinder can be shifted into the second position by application of compressed air via the tube associated with the second position of the piston, with the movement of the cylinder piston transferred to the stopper via the piston rod and a rigid component or a joint mechanism. While the position of the cylinder piston is in the second position, the free end of the stopper is directed toward the side edge and reaches the side edge of the pane to be immobilized and the position of the pane is fixed thereby, i.e., the attaching means is activated. By applying compressed air via the tube associated with the first position of the piston, the cylinder piston can be shifted back into the first position, with the movement of the cylinder piston transferred to the stopper via the piston rod and a rigid component or a joint mechanism. The free end of the stopper is now again offset back and/or upward compared to the second position in the plane of the pane and the position of the pane is no longer fixed, i.e., the attaching means is deactivated.

In the present application, the term “reaches” means that the distance between the free end of the stopper and the side edge of the pane to be immobilized corresponds at most to the previously selected positional tolerance, for example, is at most 4 mm, in particular at most 2 mm, preferably at most 1 mm, particularly preferably at most 0.5 mm, most particularly preferably between 0.1 and 0.5 mm, in particular 0.1 mm. Thus, the free end of the stopper in the second position touches the side edge of the pane or is distanced, corresponding to the positional tolerance, for example, at most 4 mm, in particular at most 2 mm, preferably at most 1 mm, particularly preferably at most 0.5 mm, most particularly preferably between 0.1 and 0.5 mm, in particular 0.1 mm therefrom.

In one embodiment, for example, in the second position, the free end of the stopper is directed toward the side edge and distanced 4 mm from the side edge of the pane; and, in the first position, the free end is offset back and/or upward in the plane of the pane and preferably distanced more than 4 mm from the side edge of the pane.

In another embodiment, for example, in the second position, the free end of the stopper is directed toward the side edge of the pane and distanced 2 mm from the side edge of the pane; and, in the first position, is offset back and/or upward compared to the second position in the plane of the pane and preferably distanced more than 2 mm, in particular more than 4 mm from the side edge of the pane.

Preferably, the distance between the free end of the stopper and the side edge of the pane, in the second position, in which the free end of the stopper is directed toward the side edge, is at most 2 mm, in particular at most 0.5 mm, preferably 0.2 to 0. mm particularly preferably 0.1 to 0.5 mm, most particularly preferably 0.1 mm and the distance between the free end of the stopper and the side edge of the pane in the first position is more than 4 mm.

In one embodiment, the free end of the stopper touches the side edge of the pane to be immobilized when the at least one pane immobilization means is activated and, consequently, the stopper, and thus the free end of the stopper, is situated in the second position.

Preferred are the embodiments in which the free end of the stopper does not touch the side edge of the pane to be immobilized, for example, is distanced at least 0.1 mm therefrom, when the stopper, and thus the free end of the stopper, is situated in the second position. In this manner, the marking of the pane, i.e., impressions of the stopper on the side edge of the pane and/or adhesion of the pane on the stopper can be prevented or at least minimized.

The values indicated here and in the following for the distances between the free end of the stopper and the side edge of the pane refer in each case to the distances existing when the carrier mold is still situated in the resting position before transport. During transport of the carrier mold and the accelerations associated therewith, the pane can slip on the support surface of the carrier mold due to its inertia, causing the distances to change. During transport to the right, for example, with positive acceleration, as result of inertia, the pane can slip on the support surface of the carrier mold at most to the free end of the stopper of an immobilization means arranged behind the pane in the transport direction, i.e., on the left side of the carrier mold. In the present case, upon deceleration, the pane can, due to its inertia, slip on the support surface of the carrier mold at most to the free end of the stopper of an immobilization means arranged in front of the pane in the transport direction, i.e., on the right side of the carrier mold.

The free end of the stopper is, in the second position, i.e., in the activated mode, directed toward the side edge of the pane. In the activated form, the stopper is preferably oriented on the vertical plane central to the side edge of the pane to be immobilized.

In an embodiment of the invention, the support surface is planar and the stopper is oriented parallel to the support surface of the pane on the carrier mold when the stopper is situated in the second position and thus the at least one pane immobilization means is activated, whereas, in contrast, the stopper is not oriented parallel to the support surface of the pane on the carrier mold when the stopper is situated in the first position and thus the at least one means is deactivated. This means the stopper is, in the first position, offset upward compared to the second position. By means of the parallel orientation in the activated mode, the risk of the upward sliding of the free end of the stopper over the side edge of the pane, which often has a C-cut, can be prevented or at least minimized when the fixing means is activated.

In a preferred embodiment, the support surface is planar and the stopper is oriented parallel to the upper side and the support surface of the pane on the carrier mold, both when the immobilization means according to the invention is activated and when the means is deactivated. This means that, in the first position, the stopper is set back compared to the second position on the same plane. This embodiment also prevents or minimizes the risk of slippage of the free end of the stopper over the side edge of the pane, in particular, when the side edge of the pane has a C-cut. Such an embodiment with a stopper oriented parallel to the upper side and the support surface of the pane during activation and deactivation of the means according to the invention is also suitable in particular for positionally fixing a pane, when only a limited access space is available for the tool for the positional fixation, such as, for example, in a bending station between the bending ring and the bending mold. By means of the parallel orientation of the stopper, the access space necessary for the stopper remains the same during activation and deactivation and thus, for example, the stopper does not make contact with the bending mold either while the at least one immobilization means according to the invention is activated or while the at least one means is deactivated.

In another preferred embodiment, the means for moving the stopper between a first position and a second position is implemented such that the free end of the stopper rests both in the first position and in the second position with its lower side on the upper side of the carrier mold. The lower side of the free end of the stopper thus slides over the upper side of the carrier mold upon deactivation of the stopper. This embodiment as well is particularly suitable for positional fixation of a pane when there is only limited access space for the tool for positional fixation, for example, in a bending station between a bending ring and a bending mold.

The at least one immobilization means according to the invention enables a reversible positional fixation of the pane. After placement of the pane on the carrier mold, the means for moving the stopper between a first position and a second position moves the stopper from the first position into the second position, in which the free end of the stopper is directed toward the side edge of the pane and reaches it, i.e., the distance between the side edge of the pane and the free end of the stopper corresponds at most to the previously selected positional tolerance, for example, is at most 4 mm, in particular at most 2 mm, preferably at most 1 mm, particularly preferably at most 0.5 mm, most particularly preferably between 0.1 mm to 0.5 mm, in particular 0.1 mm, and the immobilization means is activated. In this manner, the pane can be immobilized in its position on the carrier mold even when the carrier mold is subjected to high accelerations in a horizontal direction. In order to be able to again remove the pane from the carrier, the stopper can be moved, by the means for moving the stopper between a first position and a second position, back into the first position, in which the immobilization means is deactivated and the free end of the stopper is offset back and/or upward compared to the second position in the plane of the pane. In the first position, the distance between the free end of the stopper and the side edge of the pane is preferably greater than in the second position.

The at least one immobilization means thus offers the capability of reversible positional fixation of a pane. The use of a means for moving the stopper between a first position and a second position, which is preferably implemented as a cylinder, in particular as a pneumatic cylinder operated with compressed air, for immobilizing the pane on the support surface of the carrier mold enables quick activation or deactivation of the at least one means and thus immobilization and, consequently, for example, short cycle times of, for example, 10 seconds in a bending operation. In the case of positional fixation of a pane with a means that has no means for moving the stopper between a first position and a second position and in which the immobilization of the pane is activated, for example, by screwing stoppers, between which the pane is clamped, onto the carrier mold, and loosening or unscrewing the stoppers is necessary for deactivation of the immobilization, such short cycle times are, for example, not possible and, moreover, tools for screwing the stoppers are additionally needed.

Preferably, the means for moving the stopper between a first position and a second position, which, for example, can be implemented as a cylinder, made of a heat-resistant, in particular high-temperature-resistant, material. The means for moving the stopper can, for example, be made of a metal or a metal-containing alloy, in particular of stainless-steel. Heat-resistant, in particular high-temperature-resistant, materials are also, for example, nickel-based or cobalt-based alloys.

In another preferred embodiment of the invention, the means for moving the stopper is coated with a heat-resistant, in particular high-temperature-resistant, coating. In the case of a cylinder as a means for moving the stopper, for example, the cylinder piston, the piston rod, and/or the cylinder tube and/or, if present, the joint mechanism can be coated with a heat-resistant, in particular high-temperature-resistant coating.

In another embodiment, at least all sliding pieces of the means for moving the stopper, for example, cylinder piston, piston rod, cylinder tube, or cylinder cover of a cylinder and, if present, the joint mechanism are coated with a heat-resistant, in particular high-temperature-resistant coating or made of a heat-resistant, in particular high-temperature-resistant, material, in order to avoid or at least to minimize mechanical abrasion and wear and, thus, to provide a reliable attaching means.

Examples of such coatings are boron nitride coatings, carbon coatings, ceramic coatings, and chromium-rich coatings produced by chromium plating.

Such a heat-resistant, in particular high-temperature-resistant coating or production from such a heat-resistant, in particular high-temperature-resistant material offers the advantage that even at temperatures of more than 200° C., preferably more than 500° C., particularly preferably at temperatures of 650° C. and more, only very slight or no wear occurs. Examples of operations carried out at such high temperatures are thermal bending operations that are usually carried out at temperatures of 650° C. to 700° C.

The stopper can have any shape; preferably, it has a rectangular flat shape, i.e., a plate-like shape. The length of the stopper preferably is at least three times the width of the stopper, i.e., the stopper is preferably rod-shaped. In one exemplary embodiment, the stopper is 2 mm to 100 mm, preferably 5 mm to 30 mm wide and 5 mm to 250 mm, preferably 15 mm to 150 mm long. The thickness of the stopper is at least 0.1 mm and preferably less than the thickness of the glass pane to be immobilized. With the typical thickness of a glass pane of 0.5 mm to 10 mm, preferably 1 mm to 5 mm, the stopper is preferably between 0.3 mm and 9.8 mm thick, particularly preferably between 0.8 mm and 4.8 mm.

The stopper can, for example, be made of a metal or a metal-containing alloy, for example, stainless steel, or of ceramic. Production of the stopper from a heat-resistant, preferably high-temperature-resistant material such as stainless steel or ceramic, offers the advantage that the means according to the invention can be used in this embodiment in operations at temperatures of more than 200° C., preferably more than 500° C., particularly preferably at temperatures of 650° C. or more. Examples of such an operation at relatively high temperatures are thermal bending operations that are usually carried out at temperatures from 650° C. to 700° C.

In one embodiment, the free end of the stopper that faces the side edge of the pane and, thus, reaches the side edge of the pane when the means according to the invention is activated, i.e., the distance between the side edge of the pane and the free end of the stopper corresponds at most to the previously selected positional tolerance, for example, is at most 4 mm, is rounded over the entire width, as a result of which marking of the pane in the case of contact can be minimized or even avoided.

In a preferred embodiment, the stopper, in particular the free end of the stopper, is covered with a heat resistant, preferably high-temperature-resistant, fiber material or felt known to the person skilled in the art. This attenuates the contact between the stopper and the pane and, thus, upon contact between the stopper and the pane, the risk of marking of the pane and/or of adhesion of the pane to the stopper is reduced or even avoided. In addition, the fiber material or felt provides thermal isolation of the pane from the stopper. The fiber material or the felt is usually woven, non-woven, knotted, or knitted and preferably has a thickness between 0.1 mm and 8 mm, particularly preferably between 0.3 mm and 5 mm, most particularly preferably between 0.5 mm and 2 mm. Examples of such a heat-resistant fiber material are glass fiber materials or metal fiber materials, such as stainless-steel mesh or ceramic fiber materials, or even stainless-steel mesh with interwoven ceramic fiber materials.

The thickness of the stopper or of the stopper including the fiber material is preferably less than the thickness of the pane to be immobilized. With the typical thickness of a glass pane from 0.5 mm to 10 mm, preferably 1 mm to 5 mm, the stopper including the fiber material is preferably between 0.3 mm and 9.8 mm, particularly preferably between 0.8 mm and 4.8 mm thick. This ensures, among other things, that the stopper does not come into contact with tools processing the pane from above, such as bending molds. Contact between the stopper and such tools processing the pane from above could result in damage to the stopper.

An advantage of the above-described pane immobilization means according to the invention is its compact size such that it can also be used as a tool in the case of limited access space, in particular in the above-described embodiment, in which the support surface of the pane on the carrier mold is planar and the stopper is oriented parallel to the planar support surface of the pane both while the means according to the invention is activated and deactivated or in the embodiment in which the stopper slides over the surface of the carrier mold when deactivated. Thus, a carrier mold including the immobilization means according to the invention can, for example, be integrated into a bending device without adversely affecting the bending process.

The means according to the invention for immobilizing a pane includes a holder for attachment of the means to a carrier mold, for example. The holder attaching the means preferably includes a spacer. By varying the thickness and the angle of the spacer, it is possible to adjust the angle at which the means can be arranged on the carrier mold.

The invention also relates to a carrier mold with at least one means according to the invention attached thereon for immobilization, in other words, positional fixation of a pane having a circumferential side edge on the support surface of the carrier mold, wherein the carrier mold can be transported and thus be subjected to a laterally directed movement. The at least one means according to the invention ensures that, during transport of the carrier mold even at high accelerations in a lateral direction, no or only slight lateral movement of the pane relative to the carrier mold occurs, in other words, the pane remains the stationary on the support surface of the carrier mold.

According to the invention, the carrier mold includes a substantially upward facing upper side, which includes a support surface suitable for carrying a pane having a circumferential side edge. The substantially upward facing upper side is preferably at least as large as the pane to be carried; however, it is particularly preferable for the upper side to be larger than the pane to be carried, i.e., for the upper side not to be completely covered by the pane to be carried.

Preferably, an edge surface is arranged outwardly adjacent the upper side. This points substantially toward the side; it thus forms the lateral edge of the carrier mold. A lower side that points substantially downward is arranged adjacent this edge surface.

According to the invention, the carrier mold additionally includes at least one pane immobilization means according to the invention as described above. This is arranged relative to the support surface such that, in the second position, the free end of the stopper is directed toward the side edge of the pane and the distance between the free end of the stopper and the side edge of the pane in the second position corresponds at most to the previously selected positional tolerance, for example, is at most 4 mm. In the first position, the free end of the stopper is offset back and/or upward compared to the second position in the plane of the pane.

In an embodiment of the carrier mold according to the invention, the distance between the free end of the stopper and the side edge of the pane is, in the second position (B), at most 2 mm, preferably at most 0.5 mm, particularly preferably 0.1 to 0.5 mm, most particularly preferably 0.1 mm.

In a preferred embodiment of the carrier mold according to the invention, in the second position, the distance between the free end of the stopper and the side edge of the pane is at least 0.1 mm.

In another preferred embodiment of the carrier mold according to the invention, the distance between the free end of the stopper and the side edge of the pane is at least 0.1 mm and at most 4 mm, preferably at most 2 mm, particularly preferably at most 0.5 mm.

In an advantageous embodiment of the carrier mold according to the invention, in the second position, the distance between the free end of the stopper and the side edge of the pane is exactly 0.1 mm.

In an embodiment, the at least one pane immobilization means according to the invention is attached at the upper side, the edge surface, and/or the lower side of the carrier mold. Preferably, the at least one pane immobilization means is applied on the edge surface of the carrier mold. When the means is attached at the upper side, the means is, in particular, not attached in the region of the upper side that constitutes the support surface for the pane. When, for example, the carrier mold is arranged on a transport frame, the immobilization means according to the invention can also be attached on the transport frame.

In a preferred embodiment of the invention, the carrier mold according to the invention is a frame, i.e., an annular carrier mold in particular, which surrounds an opening, preferably a press frame, in particular a press frame for a thermal bending process. The frame need not necessarily be a closed ring; it can, for example, also be open on one side.

As described above, the carrier mold can at least be subjected to acceleration. For example, the carrier mold can be transported from one position to another position laterally distanced therefrom and, in the process, first be subjected to positive acceleration and subsequently to negative acceleration at the time of deceleration.

The at least one immobilization means according to the invention is arranged on the carrier mold in particular behind or in front of the pane in the transport direction. When the carrier mold is subjected to positive acceleration in a horizontal direction during transport, preferably at least one immobilization means is arranged behind the pane. When the carrier mold is subjected to negative acceleration in a horizontal direction during transport, preferably at least one immobilization means is arranged in front of the pane in the transport direction. When the carrier mold is subjected to both positive acceleration and negative acceleration in a horizontal direction during transport, preferably at least one immobilization means is arranged behind the pane in the transport direction and at least one immobilization means is arranged on the carrier mold in front of the pane in the transport direction. The at least one pane immobilization means can in each case preferably be installed at the upper side, the edge surface, and/or the lower side of the carrier mold, with the at least one means particularly preferably attached at the edge surface.

Thus, for example, when the carrier mold is transported between two positions laterally distanced from one another, in other words, when the carrier mold is, for example, moved horizontally from left to right and, consequently, subjected to positive acceleration during the movement from the left position to the right position and is subjected to negative acceleration at the time of deceleration to the right position, both on the left side of the carrier mold and on the right side of the carrier mold in each case, at least one pane immobilization means is attached on the carrier mold at the upper side, the edge surface, and/or the lower side of the carrier mold, with the attachment of the means at the edge surface of the carrier mold preferred.

In one embodiment, the carrier mold according to the invention includes exactly two pane immobilization means, which are arranged on opposite sides of the carrier mold, preferably at the edge surface.

In another embodiment, the carrier mold includes at least four pane immobilization means according to the invention, which are preferably arranged on two opposite sides, with the means attached in particular at the edge surface.

However, at least one pane immobilization means can also be arranged on the carrier mold in each case on four different sides.

In another embodiment, at least six, preferably exactly six pane immobilization means can be arranged on the carrier mold.

In this case as well, the pane immobilization means are preferably arranged on the carrier mold behind or in front of the pane in the transport direction; particularly preferably, at least three means are arranged behind the pane in the transport direction and at least three means are arranged in front of the pane in the transport direction, with the means attached in particular at the edge surface of the carrier mold.

The invention also relates to a device for transporting a pane, at least comprising a carrier mold according to the invention as described above and a transport means, in other words, means for moving the carrier mold according to the invention in a horizontal direction.

The transport means can transfer acceleration to the carrier mold. Preferably, this acceleration amounts to at least 500 mm/s², or even at least 1500 mm/s², or even at least 3000 mm/s², or even at least 5000 mm/s², in particular less than 7500 mm/s². This acceleration is directed laterally, i.e., horizontally or includes at least one horizontal component. In the absence of an immobilization means, such accelerations result in destabilization of the position of the pane on the carrier outside a tolerance range. In this case, the pane slips on the carrier. In a bending operation, this improper positioning on the carrier mold results, for example, in incorrect geometry of the curved pane and in rejects in the case of narrow production tolerances. In a bending operation, the positional tolerance is, for example, generally ±0.5 mm. Consequently, in a bending operation, the embodiments of carrier molds according to the invention with at least one immobilization means according to the invention in which, in the second position, the free end of the stopper is directed toward the side edge of the pane, is spaced at most 0.5 mm from the side edge of the pane. In this manner, improper positioning of the pane outside positional tolerance can be avoided.

The transport means can, for example, be used for transporting a pane from one position to another in a glass treatment process, in particular in a thermal bending device or a hot bending device. In this case, the positions of the transport means can, in particular, correspond to those that enable interaction of tools with the pane. Such tools are generally arranged above the pane. The transport device according to the invention offers a benefit, in particular, with use during rapid transport of a pane between two positions, in particular in a chamber heated to bending temperature. The transport device according to the invention moves back and forth between these two positions and pauses at each of these positions. For example, the first position can be the position in which the carrier mold is situated directly under a first bending mold, and the second position can be the position in which the carrier mold is situated directly under a second bending mold. The carrier mold repeatedly moves back and forth between the two positions and pauses in each of the two positions. On the way back from the first position, a pane is situated on the carrier mold and in the return from the second position to the first position, the carrier mold is empty, in other words, there is no pane thereon. By means of the at least one immobilization means according to the invention on the carrier mold according to the invention, it is possible to ensure that, upon activation, the pane does not slip outside a tolerance range during transport on the carrier mold. Thus, particularly high production accuracy and good optical quality of the curved pane can be achieved. Slippage of the pane outside the tolerance range would result in significant losses in bending quality and/or could result in destruction of the pane during the bending process. In general, the tolerance range, i.e., the positional tolerance of the pane in a horizontal direction in the bending operation amounts to ±0.5 mm. The means for moving the stopper between the first position (A) and the second position (B) of the immobilization means according to the invention enables immobilization of the pane as a reversible process. Depending on the position of the stopper, the immobilization means is activated (second position) or deactivated (first position). In the second position, the free end of the stopper is directed toward the side edge of the pane and the free end of the stopper reaches the side edge of the pane to be immobilized, in other words, the distance between the free end of the stopper and the side edge of the pane to be immobilized corresponds at most to the previously selected positional tolerance, is, for example, at most 4 mm, in particular at most 2 mm, preferably at most 1 mm, particularly preferably at most 0.5 mm, most particularly preferably between 0.1 and 0.5 mm, in particular 0.1 mm. The pane is immobilized. In the first position, the free end of the stopper is offset back and/or upward in the plane of the pane. In the first position, the distance between the free end of the stopper and the side edge of the pane is preferably greater than in the second position. The pane is not immobilized.

The invention also relates to a method for transporting a pane, wherein the transport has acceleration in a horizontal direction. This method includes transport of the pane by means of the above-described device according to the invention for transporting a pane.

In the method, the acceleration can be positive or negative and be at least 500 mm/s², or even at least 1500 mm/s², or even at least 3000 mm/s², or even at least 5000 mm/s², in particular less than 7500 mm/s² in a horizontal direction. The immobilization means according to the invention can be activated for immobilizing the pane during transport.

As described above in detail for the device according to the invention for transporting a pane, in the device according to the invention for transporting a pane used in the method according to the invention, the at least one means for immobilizing the pane is preferably arranged behind the pane in the transport direction. Particularly preferably, at least one immobilization means is arranged behind the pane in the transport direction and at least one immobilization means is arranged in front of the pane in the transport direction.

The invention also relates to a device for bending panes.

The glass to be bent preferably contains soda lime glass, as is customary for window panes, but can also contain other types of glass, such as borosilicate glass or quartz glass. The thickness of the glass pane is typically from 0.5 mm to 10 mm, preferably 1 mm to 5 mm.

Typical temperatures for bending glass panes are from 500° C. to 700° C., in particular about 650° C. when bending soda lime glass panes.

The device for bending panes typically comprises multiple zones structurally and functionally separable from one another. According to the invention, essential components are a transport device according to the invention and a thermal bending zone for bending heated panes that is advantageously equipped with a heating device for heating panes. In particular, the bending zone can be brought, for this purpose, to a temperature that enables plastic reshaping of panes and is typically in the range from 600° C. to 750° C. According to the invention, the transport device enables transporting the carrier mold within the bending chamber. The bending chamber preferably has a first bending mold and a second bending mold. By means of the transport device according to the invention, the carrier mold on which the pane to be bent rests can be transported, for example, laterally from a first position below the first bending mold to a second position below the second bending mold. To increase productivity, it is advantageous for the carrier mold to be moved as quickly as possible from the position below the first bending mold to the position below the second bending mold. Consequently, the carrier mold on which the pane to be bent rests can be subjected to acceleration of at least 500 mm/s², or even at least 1500 mm/s², or even at least 3000 mm/s², or even at least 5000 mm/s². Generally, the acceleration remains below 7500 mm/s². The transport device according to the invention enables the lateral movement of the carrier mold at this high resultant speed. The transport device according to the invention has a carrier mold according to the invention. This includes at least one immobilization means as described above.

The at least one immobilization means according to the invention is in particular arranged behind the pane in the device according to the invention and preferably attached at the upper side, the edge surface, and/or the lower side of the carrier mold. Preferably, if the carrier mold can be subjected during transport both to positive and to negative acceleration, both at least one pane immobilization means is arranged on the carrier mold behind the pane in the transport direction and at least one pane immobilization means is arranged in front of the pane in the transport direction.

In addition to the transport of a carrier mold within the bending chamber, the transport device according to the invention is, alternatively or additionally, also suitable for transport from the outside into the bending chamber. Thus, another aspect of the invention is a method for bending panes, wherein the pane to be bent is transported into the bending chamber by means of a transport device according to the invention.

The invention also relates to a method for bending a pane, wherein a pane heated to bending temperature and having a circumferential side edge is transported using a method according to the invention into and/or within a bending chamber heated to bending temperature, and the pane is bent in the bending chamber.

Another aspect of the invention is a method for bending panes in a bending chamber, which has a first upper bending mold and a second upper bending mold arranged laterally offset thereto. In this method, a carrier mold implemented as a press frame is used. The method according to the invention comprises the following steps:
Providing a pane heated to bending temperature,
Fixing the pane on a contact surface of the first bending mold,
Positioning a press frame for the pane in a first press frame position associated with the first bending mold,
Pressing the pane between the first bending mold and the press frame,
Transporting the pane on the press frame to a second press frame position associated with the second press frame,
Fixing the pane on a contact surface of the second bending mold,
Transporting the pane on a tempering frame to a cooling device for thermal tempering of the pane.

In one embodiment of the method according to the invention, the press frame is attached to a transport means for transport, wherein the press frame can be moved laterally by the transport means between the first press frame position and the second press frame position relative to the first and second bending mold. In addition, at least one means for immobilizing the pane pane according to the invention is arranged at the upper side, the edge surface, and/or the lower side of the press frame for immobilizing the pane on the press frame, which means can be activated for pane immobilization during transport. The at least one immobilization means is preferably arranged behind the pane in the transport direction.

The invention further extends to the use of the carrier mold according to the invention and the device according to the invention in a method, in particular a bending method, for producing panes, in particular front, rear, roof, and/or side window panes for means of transportation for travel on land, in the air, or on water, in particular for motor vehicles.

The invention also relates to the use of a pane bent by means of a method according to the invention in vehicles, preferably motor vehicles, trucks, buses, particularly preferably as a front rear, roof, or side window in vehicles.

The various embodiments of the invention can be realized individually or in any combinations. In particular, the features mentioned above and explained in the following can be used not only in the combinations indicated, but also in other combinations or in isolation, without departing from the scope of the present invention.

The invention is now explained in detail using exemplary embodiments and referring to the accompanying figures. They depict, in simplified, not-to-scale representation:

FIG. 1 a schematic plan view of an embodiment of a carrier mold according to the invention with a pane immobilization means on the carrier mold;

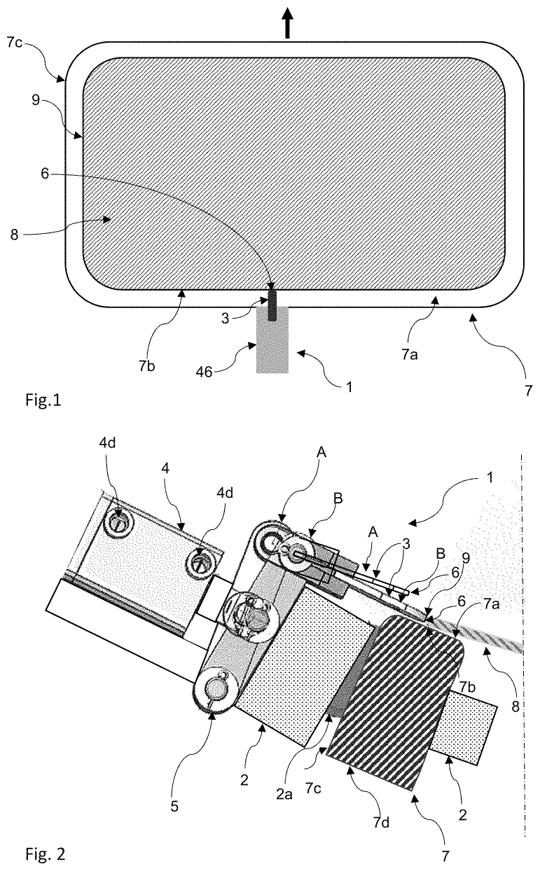

FIG. 2 a schematic representation of a detail of the cross-section of an exemplary embodiment of a carrier mold according to the invention, wherein the means for moving the stopper of the pane immobilization means is a pneumatic cylinder;

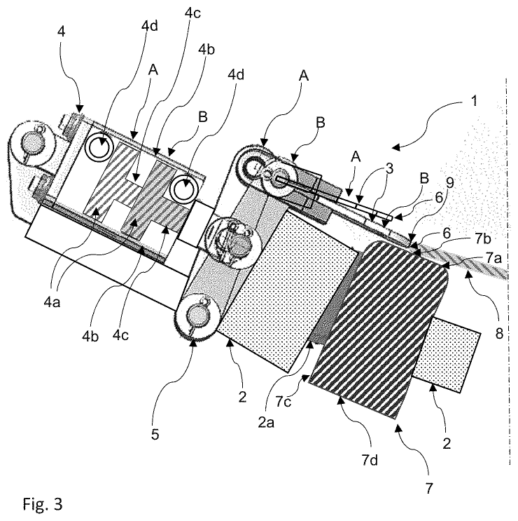

FIG. 3 a schematic representation of a detail of the cross-section of an exemplary embodiment of a carrier mold according to the invention, wherein the means for moving the stopper of the pane immobilization means is a pneumatic cylinder that is depicted in cross-section;

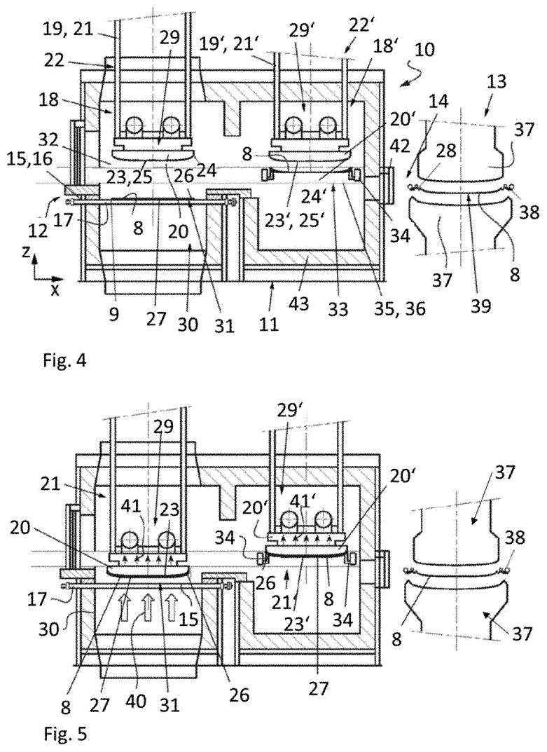

FIG. 4 through 10 schematic representations of a bending method according to the invention in different phases of the method according to the invention; and

FIG. 11 a schematic representation for illustrating the restricted access space of an immobilization means during pressing between a second bending tool and a press frame.

FIG. 1 schematically depicts the plan view of an embodiment of a carrier mold 7 according to the invention. The carrier mold 7 includes an upper side 7a with a support surface 7b, which substantially faces upward and on which a pane 8 having a circumferential side edge 9 rests. The edge surface 7c is arranged around the carrier mold 7 connecting to the upper side 7a. The edge surface 7c points substantially outward and thus constitutes the outer edge of the carrier mold 7. The carrier mold 7 also includes a means 1 for immobilizing a pane 8. In the embodiment depicted in FIG. 1, exactly one means 1 for immobilizing a pane 8 is attached to the edge surface 7c. However, according to the invention, more than one means 1 can also be attached, for example, two, three, four, five, or six or more means 1; and the attachment can, for example, be done at the upper side, the lower side, and/or the edge surface 7c. In FIG. 1, the means 1 is arranged behind the pane 8 in the transport direction (the transport direction is symbolically depicted in FIG. 1 with an arrow). When the carrier mold 7 includes more than one means 1, the means 1 is preferably arranged on opposite sides, preferably with at least one means 1 in front of the pane 8 in the transport direction. The means 1 includes a stopper 3, one end of which is connected to a means 46 for moving the stopper 3 between the first position A and the second position B and the other end of which is a free end 6. The means 46 is suitable for moving the free end 6 of the stopper 3 between a first position A and a second position B. In FIG. 1, the free end 6 of the stopper 3 is depicted in the second position B and thus in the activated form, i.e., in a position, in which it is directed toward the side edge 9 of the pane 8 and distanced from the side edge 9 of the pane 8 corresponding at most to a previously selected positional tolerance, for example, at most 4 mm, in particular at most 2 mm, preferably at most 1 mm, particularly preferably at most 0.5 mm, most particularly preferably between 0.1 mm to 0.5 mm, in particular 0.1 mm.

FIG. 2 schematically depicts the detail of a cross-section of an embodiment of a carrier mold 7 according to the invention, with at least one means 1 for immobilizing a pane 8 on the support surface 7b of the carrier mold 7. In this embodiment, a means 1 for immobilizing a pane 8 is attached on the edge surface 7c of the carrier mold 7; and the detail depicts the region of the carrier mold 7 in which the means 1 is attached at the edge surface 7c of the carrier mold 7. The means 1 has a holder 2 for attaching the means 1 to the edge surface 7c of the carrier mold 7, a stopper 3, and a cylinder 4 as means 46, with a pneumatic cylinder depicted in FIG. 2. The cylinder 4 includes, in the embodiment depicted in FIG. 2, a joint mechanism 5, with which one end of a stopper 3 is connected. The other end of the stopper 3 is a free end 6. The cylinder 4 is capable of moving the free end 6 of the stopper 3 between a first position A and a second position B via the joint mechanism 5. The first position A in FIG. 2 identifies in each case the position, when the means according to the invention 1 is deactivated, i.e., in which the free end 6 of the stopper is offset back and upward compared to the second position B in the plane of the pane; and the pane 8 is thus not immobilized on the carrier mold 7. The second position B identifies in each case the position, when the means according to the invention 1 is activated, i.e., in which the free end 6 of the stopper 3 is directed toward the side edge 9 of the pane 8 and is distanced from the side edge 9 of the pane 8, for example, at most 4 mm, in particular at most 2 mm, preferably at most 1 mm, particularly preferably at most 0.5 mm, most particularly preferably between 0.1 mm to 0.5 mm, in particular 0.1 mm; and the pane 8 is thus immobilized on the carrier mold 7. The compressed air supply lines 4d to the cylinder 4 are also discernible in FIG. 2. The cylinder 4 is operated via the compressed air supply lines 4d. The holder 2 for attaching the means 1 on the edge surface 7c of the carrier mold 7 includes a spacer 2a. By variation of the thickness and the angle of the spacer 2a, it is possible to adjust the angle at which the means 1 can be arranged on the edge surface 7c of the carrier mold 7.

FIG. 3 depicts the exemplary embodiment of the carrier mold 7 according to the invention of FIG. 2, wherein the cylinder 4 is a pneumatic cylinder, which is depicted in cross-section such that the positions of the cylinder piston 4a and the piston rod 4c connected thereto during deactivation (first position A) and during activation (second position B) as well as the cylinder tube 4b are discernible. The cylinder piston 4a is movable in the cylinder tube 4b between a first position A and a second position B. The piston rod 4c is connected to the cylinder piston 4a and the rod is, in turn, connected to the joint mechanism 5. The movement of the cylinder piston 4a and the piston rod 4c is transferred to the stopper 3 via the joint mechanism 5, with the two possible positions (first position A and second position B) of the joint mechanism discernible in FIG. 3 and with the positions A and B in FIG. 3 corresponding to the positions A and B in FIG. 2.

FIGS. 2 and 3 depict in each case an embodiment in which the stopper 3, when the means 1 is activated, is oriented parallel to a planar upper side 7a with a support surface 7b of the pane 8 on the carrier mold 7; and, when the means 1 is deactivated, is not oriented parallel to the planar upper side 7a and support surface 7a of the pane 8 on the carrier mold 7, but, instead, is pivoted upward, in other words, the free end 6 of the stopper 3 is offset back in the plane of the pane and is offset upward.

In the embodiment, in which the stopper 3 is oriented parallel to a planar upper side 7a with a support surface 7b of the pane 8 on the carrier mold 7 both when the means 1 is activated and when the means 1 is deactivated, the means for moving the stopper between a first position and a second position is designed such that the stopper 3 is oriented parallel to the upper side 7a and support surface 7b of the pane 8 even in the deactivated state. For example, when a cylinder 4 with a joint mechanism 5 is used for transmitting the movement, the uppermost joint of the joint mechanism 5 is designed such that the stopper 3 is oriented parallel to the upper side 7a and support surface 7b of the pane 8 even in the deactivated state. The free end 6 of the stopper 3 is then offset back in the first position A compared to the second position B in the plane of the pane.

FIG. 4 through 10 are schematic representations of a possible bending method in different phases of the method. In each case, for better clarity, only selected components of the bending device 10 are provided with reference characters. In FIG. 4 through 10, reference is made to a press frame 34. This press frame 34 constitutes an embodiment of the carrier mold 7 according to the invention with at least one means 1 according to the invention attached thereon for immobilizing a pane 8 having a circumferential side edge 9.

FIG. 4 depicts a situation during the bending process in which a pane 8 has been brought into the removal position 31 of the first bending station 18. The first bending mold 21 is situated in a raised position above the pane 8. The second bending mold 21′ is situated at roughly the same height as the first bending mold 21. Below the second bending mold 21′ is situated the press frame 34 in the second press frame position 33 of the second bending station 18′ with another pane 8 placed thereon. The tempering frame 38 is situated in the second tempering frame position 39 of the tempering zone 13 between the two tempering boxes 37.

FIG. 5 depicts the device 10 for bending panes 8 at a later time than FIG. 4. The first bending mold 21 has been moved downward in the direction of the pane 8 from the raised position into a first lowered position. The pane 8 has been lifted vertically from the removal position 31 in the direction toward the first bending mold 21 by blowing with the blowing device air flow 40 generated by the blowing device 30 (symbolically represented by arrows) on its lower side and is pressed by the blowing device air flow 40 against the contact surface 23 of the first bending tool 20. In the first lowered position of the first bending mold 21, the contact surface 23 is lowered enough that the pane 8 can be pressed by the blowing device air flow 40 against the contact surface 23. In addition, the pane 8 is fixed on the contact surface 23 by suction using the suction device 29. The suction device airflow 41 generating a negative pressure on the contact surface 23 is likewise symbolically represented by arrows. Due to the typically incomplete contact against the contact surface 23, a pre-bending of the pane 8 occurs only in the edge region 26. Usually, the pressing pressure resulting from the blowing device air flow 40 is insufficient to produce a final edge bending in the edge region 26 of the pane 8. On the other hand, the suction effect of the suction device 29 serves substantially only to hold the pane 8 on the contact surface 23 to which the press frame 34 has been moved below the pane 8, and has only a slight influence on the bending of the pane 8. Nevertheless, bubbles in the pane 8 can be removed by it. In the inner region 27 of the pane 8, only surface pre-bending is possible anyway due to the contact surface 23. FIG. 5 depicts a situation in which the pane 8 is already fixed on the contact surface 23.

The second bending mold 21′ has been brought from the raised position into a lowered position in which there is area-wise contact between the contact surface 23′ and the pane 8 placed on the press frame 34. The pane 8 is pressed in the edge region 26 between the outer surface section 24′ of the contact surface 23′ of the bending tool 20′ and the press surface of the press frame 34. The press surface of the press frame 34 has a shape complementary to the outer surface section 24′ of the contact surface 23. The edge region 26 of the pane 8 is preferably finally bent, i.e., obtains its final edge bending. However, it is also possible for the edge region 26 to be only pre-bent. Subsequently, the pane 8 is fixed to the contact surface 23′ by suction using the suction device 29′. It is conceivable for the contact surface 23′ to alternatively have a small distance from the pane 8 if suction of the pane 8 away by a certain distance is possible. The suction device airflow 41′ generating a negative pressure on the contact surface 23′ is symbolically represented by arrows. In contrast to the first bending mold 21, on which only holding of the pane 8 is intended and the negative pressure consequently does not cause any (at least noteworthy) bending of the pane 8, the suction of the pane 8 against the contact surface 23′ can also serve for bending the pane 8, i.e., the suction generates sufficient mechanical pressure to bend the pane 8 as desired. Thus, the pane 8 is pre-bent on the second contact surface 23′ in the inner region 27 of the pane 8. In addition, a previously generated final edge bending can be retained in the edge region 26. The tempering frame 38 is still situated in the tempering device 13 between the two tempering boxes 37.

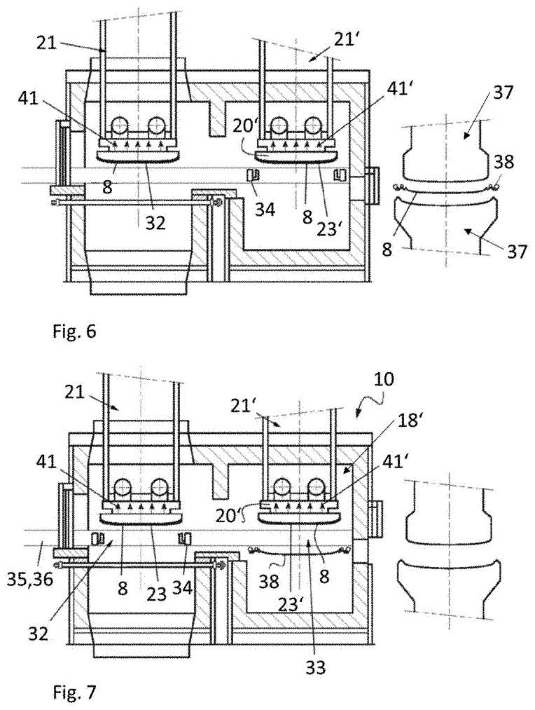

FIG. 6 depicts the device 10 for bending panes 8 at a later time than FIG. 5. The first bending mold 21 has again been moved upward into its raised position, wherein the pane 8 is fixed against the contact surface 23 by the suction device air flow 41. The second bending mold 21′ has also been moved upward into its raised position, wherein the pane 8 is fixed against the contact surface 23′ by the suction device air flow 41′. The press frame 34 is pane free and is situated below the second bending mold 21′. The tempering frame 38 is still situated in the tempering device 13 between the two tempering boxes 37.

FIG. 7 depicts the device 10 for bending panes 8 at a later time than FIG. 6. The first bending mold 21 is depicted in the situation in which it is moved downward on the way into a second lowered position above the first lowered position. The pane 8 is still fixed against the contact surface 23 by the suction device air flow 41. The press frame 34 is moved translationally on the transport means 36 in a horizontal direction (negative x-direction) by means of the transport means movement mechanism 35 from the second press frame position 33 to the first press frame position 32 and is situated below the first bending mold 21. The second bending mold 21′ is still situated in its raised position, wherein the pane is fixed against the contact surface 23′ by the suction device air flow 41′. The tempering frame 38 has moved from the tempering position 39 into the second press frame position 33 of the second bending station 18′ and is situated below the second bending mold 21′.

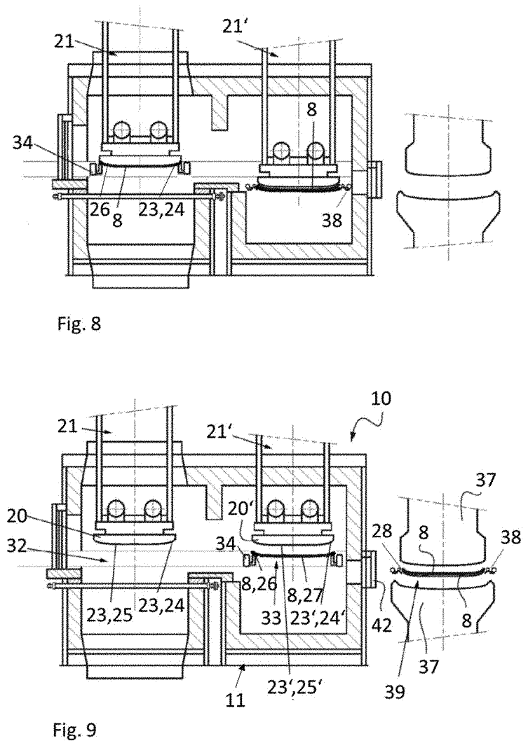

FIG. 8 depicts the device 10 for bending panes 8 at a later time than FIG. 7. The first bending mold 21 has now been moved into the second lowered position, wherein the pane 8 comes into contact with the press frame 34. The pane 8 is pressed in the edge region 26 between the outer surface section 24 of the contact surface 23 of the bending tool 20 and the press surface of the press frame 34. The press surface of the press frame 34 has a shape complementary to the outer surface section 24 of the contact surface 23. The edge region 26 of the pane 8 is pre-bent or finally bent thereby. The second bending mold 21′ has been moved into its lowered position, wherein the pane 8 is placed on the tempering frame 38.

FIG. 9 depicts the device 10 for bending panes 8 at a later time than FIG. 8. The first bending mold 21 and the second bending mold 21′ have, in each case, been moved back into their raised position. The press frame 34 has been moved translationally in a horizontal direction (positive x-direction) from the first press frame position 32 to the second press frame position 33 and is situated below the second bending mold 21′. In particular, during transport, the pane 8 situated on the press frame 34 is pre-bent in the inner region 27 by gravity. As a result of the pressing in the edge region 26, the surface pre-bending by gravity in the inner region 27 is limited. The tempering frame 38 with the pane 8 placed thereon has been moved from the second press frame position 33 of the second bending station 18′ into the tempering position 39 and is situated between the two tempering boxes 37. To enable exit from the bending zone 11, the door 42 was opened for a short period of time. Thus, a significant temperature loss in the bending chamber 11 can be avoided. During transport on the tempering frame 38, final edge bending and final surface bending of the pane 8 can occur by gravity. The tempering frame 38 has, for this purpose, an upward directed frame surface 28 for contact with the pane 8, which is suitably implemented for final edge bending. In addition, the tempering frame 38 is suitably implemented for final surface bending by gravitation.

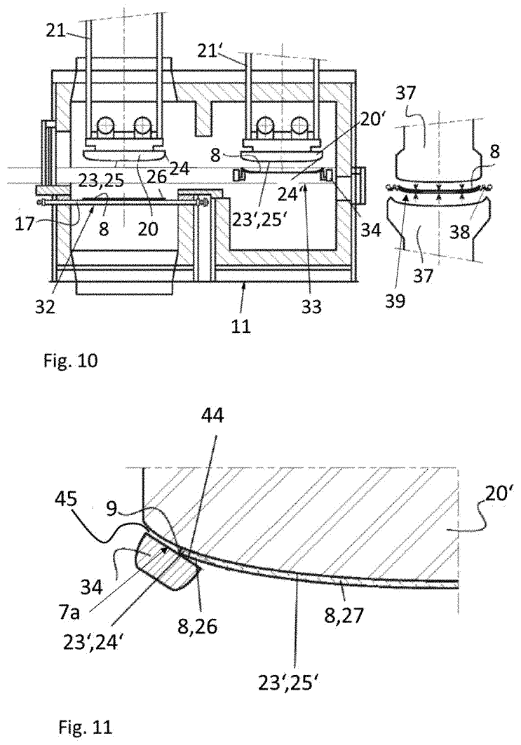

FIG. 10 depicts the device 10 for bending panes 8 at a later time than FIG. 9. The first bending mold 21 and the second bending mold 21′ are still situated in the raised position. A new pane 8 has been brought into the removal position 31 of the first bending station 18. The pane 8 situated on the press frame 34 can be pressed and suctioned by the second bending mold 21′. The pane 8 situated in the tempering zone 39 is cooled for tempering by an air flow, as illustrated by arrows. The situation of FIG. 10 is thus similar to the situation of FIG. 4. The bending process can thus be run continuously.

In the time between the time depicted in FIG. 8 and the time depicted in FIG. 9, the press frame 34 is transported from the first press frame position 32 into the second press frame position 33. During this transport, the press frame 34 is preferably subjected to acceleration of at least 500 mm/s², or even at least 1500 mm/s², or even at least 3000 mm/s², or even at least 5000 mm/s² in the lateral direction. To prevent slippage of the pane 8 outside a tolerance range, the pane 8 is immobilized on the press frame 34 during this transport by at least one means 1 according to the invention arranged on the press frame 34, with the means 1 activated during transport.

By means of this precise positional fixation of the pane 8 on the press frame 34, even when the press frame 34 is subjected to high accelerations, particularly high production accuracy, in particular in the second bending step, and particularly good optical quality of the bent pane can be achieved.

In the time between the time depicted in FIG. 5 and the time depicted in FIG. 6, the means 1 is deactivated such that the pane 8 is no longer immobilized on the press frame 34 and can thus be removed therefrom.

FIG. 11 schematically depicts the pressing of a pane 8 between a press frame 34 and a second bending mold 20′. It can be discerned that the space 45 between the press frame 34 and the bending mold 20′ via which a means has access to the pane 8 in order to immobilize it on the press frame 34 even during pressing is quite limited.

The means 1 described in the context of the invention enables immobilization of a pane 8 even in the case of such limited access space, in particular in the embodiment, in which, both in the activated state and the deactivated state, the stopper 3 of the means 1 is oriented parallel to the support surface 7a of the carrier mold (in this case, of the press frame 34) and the means is preferably attached on the edge surface 7c of the carrier mold (in this case, of the press frame 34).

### LIST OF REFERENCE CHARACTERS

A position A (first position, position in the deactivated state of the means according to the invention)
B position B (second position, position in the activated state of the means according to the invention)
1 means (for immobilizing a pane)
2 holder
2a spacer
3 stopper
4 cylinder
4a cylinder piston
4b cylinder tube
4c cylinder rod
4d compressed air supply lines
5 joint mechanism
6 free end of the stopper
7 carrier mold
7a upper side
7b support surface
7c edge surface
7d lower side
8 pane
9 side edge
10 bending device
11 bending chamber
12 preheating zone
13 tempering zone
14 tempering frame movement mechanism
15 pane transport mechanism
16 roller bed
17 roller
18,18′ bending station
19,19′ holder for bending mold
20,20′ bending tool
21,21′ bending mold
22,22′ holder movement mechanism
23,23′ contact surface
24,24′ outer surface section
25,25′ inner surface section
26 edge region
27 inner region
28 frame surface
29,29′ suction device
30 blowing device
31 removal position
32 first press frame position
33 second press frame position, first tempering frame position
34 press frame
35 transport means movement mechanism
36 transport means
37 tempering box
38 tempering frame
39 second tempering frame position
40 blowing device air flow
41,41′ suction device air flow
42 second bending chamber door
43 bending chamber wall
44 press surface
45 access space
46 means (for moving the stopper)

1. An apparatus for immobilizing a pane having a circumferential side edge within a positional tolerance on a carrier mold, comprising:
a stopper which is movable between a first position and a second position, which has a free end and an end opposite the free end that is connected to a means for moving the stopper between the first position and the second position, wherein in the second position, the free end of the stopper is directed toward the side edge of the pane to be immobilized and a distance between the free end of the stopper and the side edge corresponds at most to the positional tolerance, and
in the first position, the free end of the stopper is offset back and/or upward in the plane of the pane compared to the second position.

2. The apparatus according to claim 1, wherein the distance between the free end of the stopper and the side edge of the pane to be immobilized is at least 0.1 mm in the second position.

3. The apparatus according to claim 1, wherein the distance between the free end of the stopper and the side edge of the pane to be immobilized is at most 4 mm in the second position.

4. The apparatus according to claim 1, wherein the stopper is rectangular and the thickness of the stopper is less than the thickness of the pane to be immobilized and/or wherein the free end of the stopper is rounded.

5. The apparatus according to claim 1, wherein the stopper is made of ceramic or a metal or a metal-containing alloy, wherein at least the free end of the stopper is covered with a heat-resistant fiber material and the thickness of the stopper including the fiber material is less than the thickness of the pane to be immobilized.

6. The apparatus according to claim 1, wherein at least all sliding pieces of the means are made of a heat-resistant material or are coated with a heat-resistant coating.

7. The apparatus according to claim 1, wherein the means for moving the stopper is a cylinder.

8. A carrier mold for a pane, comprising
a support surface that is suitable for carrying a pane having a circumferential side edge, and
at least one apparatus according to claim 1 for immobilizing the pane on the support surface.

9. The carrier mold according to claim 6, wherein the carrier mold is implemented as a frame.

10. A device for transporting a pane, comprising
a carrier mold according to claim 8, and
a means for moving the carrier mold in a horizontal direction.

11. The device according to claim 10, wherein the means for moving the carrier mold can transfer an acceleration of at least 500 mm/s² to the carrier mold in a horizontal direction,
wherein the at least one apparatus includes a first, a second and a third apparatus, wherein the first apparatus is arranged behind the pane in the transport direction, the second apparatus is arranged behind the pane in the transport direction and the third apparatus is arranged in front of the pane in the transport direction.

12. A method for transporting a pane, comprising transporting the pane by means of a device according to claim 10, wherein the transport includes at least acceleration in a horizontal direction and wherein, during transport, the free end of the stopper is positioned in the second position.

13. The method according to claim 12, wherein the acceleration is at least 500 mm/s² in a horizontal direction.

14. A method for bending a pane, comprising:
transporting a pane having a circumferential side edge and heated to bending temperature using a method according to claim 12 into and/or within a bending chamber heated to bending temperature, and
bending the pane in the bending chamber.

15. The method according to claim 14,
wherein transport occurs within a bending chamber, which includes a first upper bending mold and a second upper bending mold arranged laterally offset thereto, and the carrier mold serves as a lower press frame.

16. A method comprising utilizing a pane bent by means of a method according to claim 14 in a vehicle, as a front, rear, roof, or side window.

17. The apparatus according to claim 3, wherein the distance between the free end of the stopper and the side edge of the pane to be immobilized is from 0.1 mm to 0.5 mm.

18. The apparatus according to claim 7, wherein the cylinder is a pneumatic cylinder.

19. The carrier mold according to claim 9, wherein the carrier mold is implemented as a press frame for a thermal bending process.

20. The device according to claim 11, wherein the acceleration is less than 7500 mm/s².
